(19) United States
(12) Patent Application Publication
(10) Pub. No.: US 2004/0100649 A1
(43) Pub. Date: May 27, 2004

(54) Systems and methods of automatic recovery for disabled printers

(76) Inventors: Bruce L. Johnson, Eagle, ID (US); Bradley J. Anderson, Boise, ID (US); William I. Herrmann, Eagle, ID (US)

Correspondence Address: HEWLETT-PACKARD COMPANY, Intellectual Property Administration, P.O. Box 272400, Fort Collins, CO, 80527-2400, US

(21) Appl. No.: 10/303,311

(22) Filed: Nov. 22, 2002

(51) Int. Cl. G06F 15/00; G05B 13/02; G06F 3/12

(52) U.S. Cl. 358/1.14; 358/1.13

(57) ABSTRACT

Methods of recovering from disabled printer states due to the unavailability of print consumables such as toner, ink, or other colorants. Some of those methods use a conversion to a degraded format, such as process black or grayscale. Others of those methods transfer a print job to a printer that is not disabled, the print job optionally including instructions in a printer language or a metafile. A color printer capable of recovering from a disabled printer state due to the unavailability of colorants by converting a print job to a degraded format, such as true black to process black or color to grayscale printing. A printer capable of recovering from a disabled printer state due to the unavailability of colorants by forwarding a print job to another compatible printer or a print server. A system capable of recovering from a printer having unavailable colorants necessary for printing a print job including a printer and a print server, the printer forwarding the print job to the print server, the print server selecting an alternate printer and forwarding the print job thereto.

### BACKGROUND OF THE INVENTION

The present invention relates generally to printers in computer systems and more specifically to devices that can receive a print job and bypass a disabling state by printing in different modes or by forwarding print jobs to alternate printers.

Modern printers utilize certain consumable materials in the printing process. The most notable of these materials are media, such as paper, and colorants, such as ink or toner. When necessary materials are not available to a printer, the printer becomes disabled or inoperative.

Some printers use a single cartridge containing multiple colorants. When one colorant is exhausted normal printing may not proceed without the installation of a new cartridge. Any remaining colorants in the discarded cartridge are wasted. Furthermore, it is sometimes the case a replacement cartridge is not readily available. In this case the printer becomes inoperative for an extended period until a replacement cartridge can be obtained.

### BRIEF SUMMARY OF THE INVENTION

Embodiments of the invention provide systems and methods of printing in a substitution mode to bypass a disabled printer condition. One substitution mode is printing process black for true black. Another substitution mode is printing grayscale for color.

Other embodiments of the invention provide systems and methods of forwarding print jobs to alternate printers whereby print jobs are continued. Other embodiments of the invention provide an alternate print server, whereby a disabled printer may forward a print job to an alternate printer in an indirect fashion. Other embodiments of the invention provide alternate printers and print servers that notify an operator of the location or identifier of the alternate printer to which the print job is forwarded.

Embodiments of this invention provide advantages wherein printing may continue even though all print materials are not presently in supply.

Additional objects, advantages, and other novel features of this invention will be set forth in part in the description that follows and in part will become apparent to those skilled in the art upon examination of the following or may be learned with the practice of the invention. The objects and advantages of this invention may be realized and attained by means of the instrumentalities and combinations particularly pointed out in the appended claims. Still other objects of the present invention will become readily apparent to those skilled in the art from the following description wherein there is shown and described the preferred embodiments of this invention, simply by way of illustration of one of the modes best suited to carry out this invention. As it will be realized, this invention is capable of other different embodiments, and in its several details it is capable of modification without departing from the concept of the invention. Accordingly, the drawings and descriptions should be regarded as illustrative in nature and not as restrictive.

### BRIEF DESCRIPTION OF THE DRAWINGS

The accompanying drawings incorporated in and forming a part of the specification, illustrate a preferred embodiment of the present invention. Some, although not all, alternative embodiments are described in the following description. In the drawings:

FIG. 1 depicts a printing process that may be used in practicing the invention.

FIG. 2 is a flowchart showing a process whereby process black may be substituted for true black in the event black colorant is not available.

FIG. 3 is a flowchart showing a process whereby grayscale printing may be substituted for color printing in the event one or more chromatic colorants are unavailable.

FIG. 4 illustrates components of a printer that may be used to practice several embodiments of the invention.

FIGS. 5a and 5b are flowcharts showing a process whereby a print job may be forwarded to an alternate printer in the event the current printer is disabled.

FIG. 6 illustrates systems of the invention by which print jobs may be forwarded to alternate printers of the same type as originating printers.

FIG. 7 illustrates systems of the invention by which print jobs may be forwarded to alternate printers of different types as the originating printers.

FIG. 8 is a flowchart showing a process whereby print jobs containing metafiles may be forwarded to alternate printers in the event the current printer is disabled.

FIG. 9 illustrates a flowchart showing a method whereby a print server may accept a print job and forward the print job to one of a set of alternate printers.

FIG. 10 depicts systems of the invention containing a print server.

FIG. 11 depicts one embodiment of a print server.

Reference will now be made in detail to the present preferred embodiment of this invention, an example of which is illustrated in the accompanying drawings.

### DETAILED DESCRIPTION OF EXEMPLARY EMBODIMENTS OFTHE INVENTION

Generally speaking various features of the invention allow print jobs to be completed in the event colorants in one or more print cartridges are exhausted, or such cartridges are missing.

For the purposes of discussion the following definitions are provided.

Print output is an image or a set of images on media.

Colorants for the purposes of this writing are any substances which when applied to media modify the color or brightness thereof. Examples of colorants are liquid and solid inks, both dye or pigment based, and dry and liquid toners.

A printer is a device that deposits colorants to media forming images thereon. Two common printer types use toner and ink, those printers being laser printers and thermal ink jet printers, respectively.

A printer language is a set of commands whereby print output is defined. Every printer interprets one or more printer languages to produce print output. Examples of printer languages are PCL (printer control language), HP/GL, PCL-XL, Postscript, and text.

A print job is a set of information sent to a printer, one of the information elements being a set of printer language instructions. Other information may be included in the print job such as the sender's logical location, and printer configuration for the print job.

A disabled print job is a print job sent to a printer not having the necessary materials, such as colorants and paper, to execute the print job. Likewise a disabled printer is a printer not having the necessary materials to execute a print job.

A bypass mode is a substitution mode or a forwarding mode of operation that permits a print job to complete even though the original printer does not have the necessary print materials to complete the print job.

A metafile, for the purposes of this writing, is a representation of a print job that is not specific to any particular printer type or printing language. Examples of metafile formats are the Windows metafile format, Postscript, and dvi format as output from a TeX interpreter.

Monochrome printing is printing in a single color, usually black on white media.

Grayscale printing is printing that produces the appearance of graduated shades of a particular color, usually black.

Chromatic colorants are colorants that are not black, but are colored. Commonly used chromatic colorants are colored cyan, magenta, and yellow. Chromatic colorants may be applied in combination to produce multiple shades and hues are, for the purposes of this writing, composite chromatic colorants.

Color printing is printing that produces shades of a spectrum of colors. The most common method uses graduations of three chromatic colorants in combination to produce a composite with specific shade and hue. The most commonly used colorants are colored cyan, magenta, and yellow, which colors are used in the CMY process. A black colorant is often added to provide a true black and also to provide shading; a process that uses black colorant additively in a CMY process becomes a CMYK process.

True black is a black colorant applied without combination of other colorants to media.

Process black is a mixture of chromatic colorants that produces an approximation to true black. Process black, in most cases, is inferior to true black in that process black does not appear to be as black as true black. In some printers process black may only be printed in a lower resolution than true black.

A degraded format is a print format having a degraded quality in some way, such as printing process black for true black, or grayscale for color. A degraded print job is a print job that has been modified from an original print job to print using a degraded format.

A logical location is a representation of location of an object whereby it may be recognized. A logical location may, but is not required to be, a physical location, a digital address, a network address or named object, or other identifier such that the logical location specifies a unique object. For example, a logical location might be a description of a port through which that object is accessed such as LPTi on a personal computer. A logical location may also be a network identifier, such as an IP address, MAC address, or other identifier.

An interface, for the purposes of this writing, is a logical channel whereby information may be communicated consisting of a physical medium such as a wire or line of sight, hardware for transmission or reception, and may also include software to handle underlying protocols. Multiple interfaces may share the same medium, hardware, and software. For example, a device may have a single Ethernet port through which it may communicate with multiple devices over the same cable, thus providing the capability of forming multiple logical interfaces or channels. Interfaces should not be construed to be limited to individual wires, mediums, lines of sight, networks, or sessions.

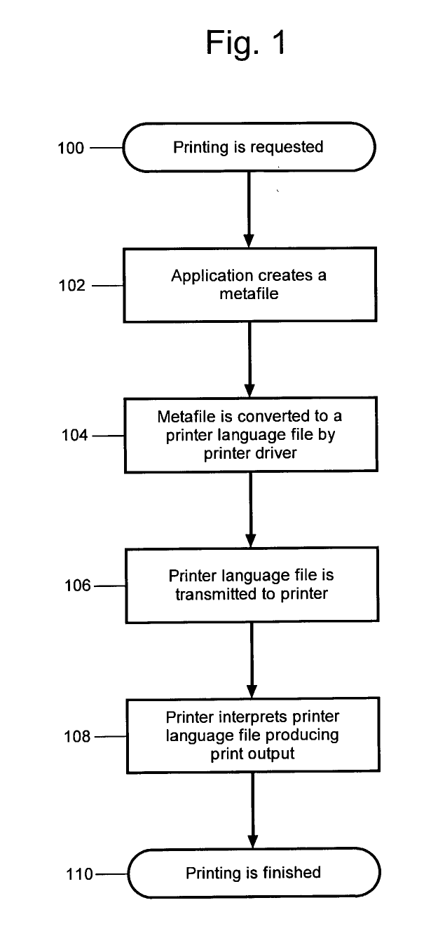

FIG. 1 illustrates the operation of a printing process for implementing the invention in the operation of modern operating systems. Printing is requested, as shown in step 100, typically by a user commanding an application to print through the use of a menu or other interaction. The application then creates a metafile, as shown in step 102. The metafile is then converted to a printer language file, containing printing commands in the printer language of the destination printer, as shown in step 104. There are a few printer languages, such as Postscript, that are also device independent. The conversion of such metafiles to device independent printer language files may be simplified; it is also possible that the conversion is as simple as copying the metafile. Execution proceeds to step 106, in which the printer language file is transmitted to the printer. Examples of mediums of such transmissions are serial, parallel, or network connections. And finally execution proceeds to step 108, wherein the printer interprets the commands in the printer language file and produces print output which is usually images on paper or other media.

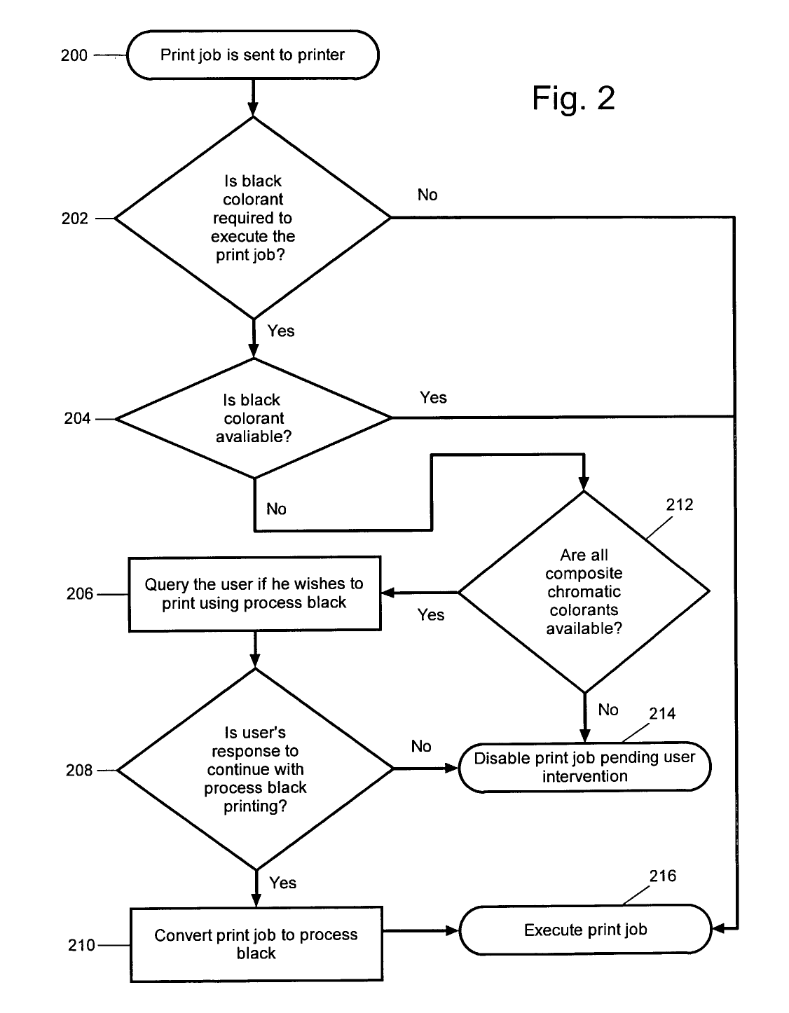

FIG. 2 illustrates by example a method of the invention, whereby a print job sent to a color printer having black text or image components may be printed using process black if black colorant is not available. A print job is sent to a printer, shown in step 200. A determination of whether or not black colorant is required to execute the print job may optionally be made, shown in step 202. If black colorant is not required, the print job may proceed, as shown in step 216. If black colorant is required, or if optional step 202 is omitted, execution proceeds to step 204. A determination of whether or not black colorant is available for printing is made in step 204. If black colorant is available, the print job may proceed, as shown in step 216. If black colorant is not available, execution proceeds to optional step 212, or step 206 if optional step 212 is omitted. In optional step 212 a determination is made as to whether or not a complete set of composite chromatic colorants are available, which colorants are required to print process black. If the composite chromatic colorants are available, execution proceeds to step 206, otherwise execution proceeds to step 214. In step 214 execution is halted until intervention occurs that causes the necessary materials to be present to execute the print job. In step 206 a query is presented wherein the user may indicate if process black is an acceptable alternative to true black colorant. The response of the query of step 206 is collected. Such response directs the decision of step 208. In step 208, if the user accepts process black printing execution proceeds to step 210, otherwise execution proceeds to step 214 which halts the execution. In step 210 the print job is converted such that process black is substituted for true black, within the context of the printer language of the specific printer. Such a conversion process will vary depending on the type of color printer; those skilled in the art will know how such a conversion may be made. The converted process black print job is then printed, as shown in step 216.

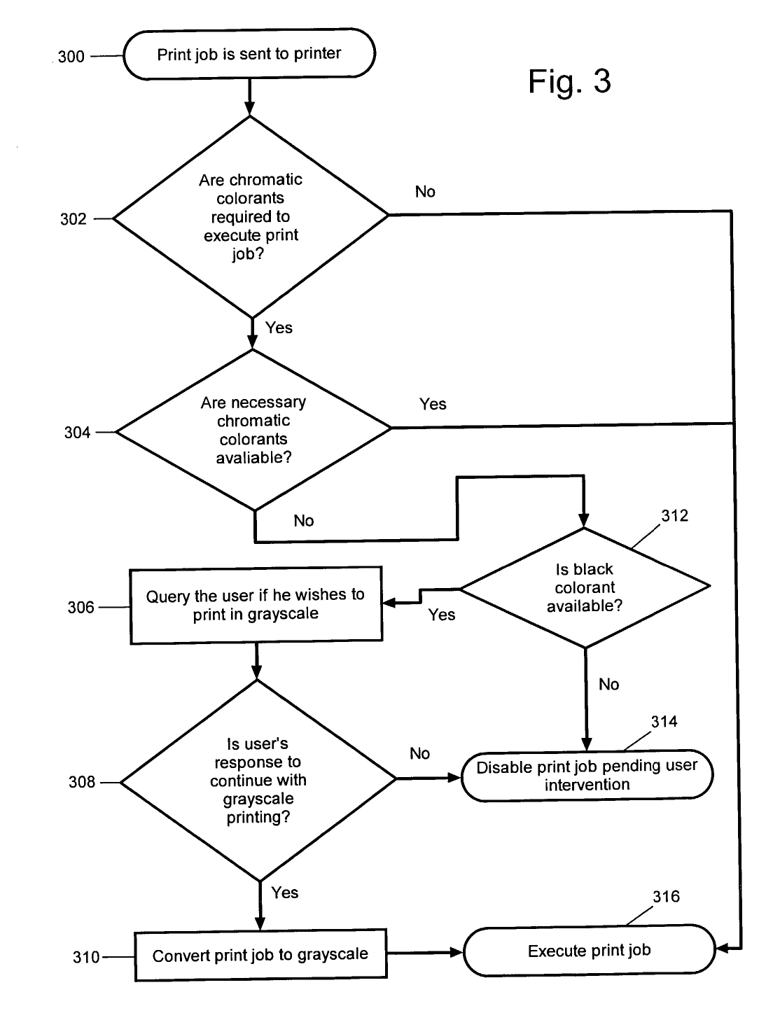

FIG. 3 illustrates by example another method of the invention, whereby a print job sent to a color printer having non-black or color text or image components may be printed in grayscale if one or more of the composite chromatic colorants are not available. A print job is sent to a printer, shown in step 300. A determination of whether or not chromatic colorants are required to execute the print job may optionally be made, as shown in step 302. If chromatic colorants are not required, the print job may proceed, as shown in step 316. If chromatic colorants are required, or if optional step 302 is omitted, execution proceeds to step 304. A determination of whether or not all chromatic colorants are available for printing is made in step 304. If all chromatic colorants are available, the print job may proceed as shown in step 316. If all chromatic colorants are not available, execution proceeds to optional step 312, or step 306 if step 312 is omitted. In optional step 312 a determination is made as to whether or not black colorant is available for grayscale printing. If black colorant is available, execution proceeds to step 306, otherwise execution proceeds to step 314. In step 314 execution is halted until intervention occurs that causes the necessary materials to be present to execute the print job. In step 306 a query is presented wherein the user may indicate if grayscale printing is an acceptable alternative for color printing. The response of the query of step 306 is collected. Such response directs the decision of step 308. In step 308, if the user accepts grayscale printing execution proceeds to step 310, otherwise execution proceeds to step 314 which halts the execution. In step 310 the print job is converted from color printing to grayscale printing within the context of the printer language of the specific printer. Such a conversion process will vary depending on the type of color printer; those skilled in the art will know how such a conversion may be made. The converted grayscale print job is then printed, as shown in step 316.

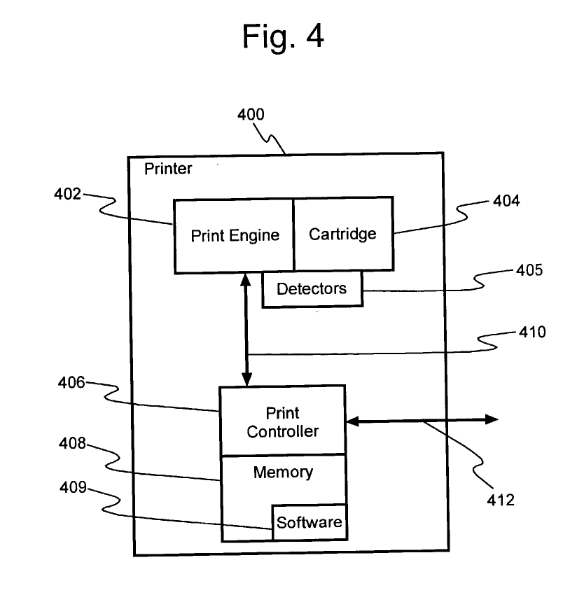

An example system of the invention may be described using FIG. 4, whereby a print job submitted to a color printer may be printed in a degraded format if the necessary materials are not available to execute the print job normally. Printer 400 is a color printer designed to execute print jobs. Printer 400 contains a print engine 402, which contains electrical and mechanical components necessary to produce print output. One or more cartridges 404 containing black and composite chromatic colorants are attachable to print engine 402, such that these colorants may delivered to media at commanded times. One or more detectors 405 are provided whereby print controller 406 may determine whether black colorant, one or more composite chromatic colorants, or both are not available for printing. Examples of detectors 405 are a sensor detecting the presence of cartridge 404, a sensor detecting the level of colorant in cartridge 404, a calculation estimating the amount of colorant remaining in cartridge 404, or a sensor that determines whether colorant is flowing during the printing process from cartridge 404. Controller 406 is connected to print engine 402 by connection 410, whereby print engine 402 may be controlled and delivery of colorants in cartridges 404 may be commanded. Controller 406 functions to process a print job containing a printer language file to a series of commands to print engine 402 such that appropriate print output results. Print controller 406 interfaces with memory 408. Memory 408 contains software 409 for the interpretation of a printer language file and the production of a series of commands to print engine 402. Memory 408 also contains software necessary to read the detectors 405. Software in memory 408 may implement the functions shown in steps 202, 204, 206, 208, 210, 212, 214, and 216. Software in memory 408 may also implement the functions shown in steps 302, 304, 306, 308, 310, 312, 314, and 316. Software in memory 408 also performs the function of receiving a print job through interface 412 from a submitter, optionally returning printing status back to the submitter. Examples of interface 412 are a network port, an infrared port, and a parallel port. Software in memory 408 may also read a flag specifying whether or not print jobs may be converted to a degraded format. This flag may be nonvolatile or transient, and may be implemented in many possible means. At least one way of setting this flag is provided. Examples of such means are a binary switch, a menu option presented by a printer user interface, or setting by a print driver running on the submitter's workstation. The reading of the flag determines whether or not conversion of a disabled print job will be performed to allow the print job to proceed in a degraded format, or halted for future intervention.

Another example system of the invention may be described using FIG. 4, whereby a print job submitted to a first printer may be forwarded to an alternate compatible printer if the necessary materials are not available to execute the print job normally on the first printer. Printer 400 is a printer designed to execute print jobs. Printer 400 contains a print engine 402, which contains electrical and mechanical components necessary to produce print output. One or more cartridges 404 containing one or more colorants are attached to print engine 402, such that these colorants may delivered to media at commanded times. One or more detectors 405 are provided whereby print controller 406 may determine whether black colorant, one or more composite chromatic colorants, or both are not available for printing. Examples of detectors 405 are a sensor detecting the presence of cartridge 404, a sensor detecting the level of colorant in cartridge 404, a calculation estimating the amount of colorant remaining in cartridge 404, or a sensor that determines whether colorant is flowing during the printing process from cartridge 404. Controller 406 is connected to print engine 402 by connection 410, whereby print engine 402 may be controlled and delivery of colorants in cartridges 404 may be commanded. Controller 406 functions to process a print job containing a printer language file to a series of commands to print engine 402 such that appropriate print output results. Print controller 406 interfaces with memory 408. Memory 408 contains software for the interpretation of a printer language file and the production of a series of commands to print engine 402. Memory 408 also contains software necessary to read the detectors 405. Software in memory 408 may implement the functions shown in steps 502, 504, 506, 508 512, and 514. Software in memory 408 also performs the function of receiving a print job through interface 412 from a submitter, optionally returning printing status back to the submitter. Examples of interface 412 are a network port, an infrared port, and a parallel port. Software in memory 408 may also read a memory element whereby at least a logical location for an alternate printer may be stored. This memory element may be nonvolatile or transient, and may be implemented in many possible means. At least one way of setting this flag is provided. Examples of such means are a configuration option presented by a printer user interface, or setting by a print driver running on the submitter's workstation. The reading of the memory element determines whether or not forwarding of a disabled print job is to be performed, or halted for future intervention. Software in memory 408 further performs the function of forwarding a print job to an alternate printer through an interface, shown by example as 412. A second interface may be provided for such a forwarding function if desired.

Another alternative embodiment of the system of the invention may be described using FIG. 4, whereby a print job submitted to a first printer may be forwarded to an alternate print server if the necessary materials are not available to execute the print job normally on the first printer. Printer 400 is a printer designed to execute print jobs. Printer 400 contains a print engine 402, which contains electrical and mechanical means necessary to produce print output. One or more cartridges 404 containing one or more colorants are attached to print engine 402, such that these colorants may delivered to media at commanded times. Print engine 402 may also embody means of detecting when materials, such as colorants, are not available for printing. Examples of such means are a sensor detecting the presence of cartridge 404, a sensor detecting the level of colorant in cartridge 404, or a calculation estimating the amount of colorant remaining in cartridge 404. Controller 406 is connected to print engine 402 by connection 410, whereby print engine 402 may be controlled and delivery of colorants in cartridges 404 may be commanded. Controller 406 embodies processing means whereby a print job containing a printer language file may be processed to a series of commands to print engine 402 such that appropriate print output results. Print controller 406 interfaces with memory 408. Memory 408 contains software for the interpretation of a printer language file and the production of a series of commands to print engine 402. Memory 408 also contains software interfacing with the means of detection of material availability. Software in memory 408 may implement the functions shown in steps 802, 804, 806, 808, 812, and 814. Software in memory 408 also performs the function of receiving a print job through interface 412 from a submitter, optionally returning printing status back to the submitter. Examples of interface 412 are a network port, an infrared port, and a parallel port. Software in memory 408 may also read a memory element whereby at least a logical location for an alternate print server may be stored. This memory element may be non-volatile or transient, and may be implemented in many possible means. Means of setting this memory element are provided. Examples of such means are a configuration option presented by a printer user interface, or setting by a print driver running on the submitter's workstation. The reading of the memory element determines whether or not forwarding of a disabled print job is to be performed, or halted for future intervention. Software in memory 408 further performs the function of forwarding a print job to an alternate print server through an interface, shown by example as 412. A second interface may be provided for such a forwarding function if desired. Printer 400 may also notify the submitter that the print job has been forwarded to the alternate printer, and optionally, the identity or logical address of the alternate printer.

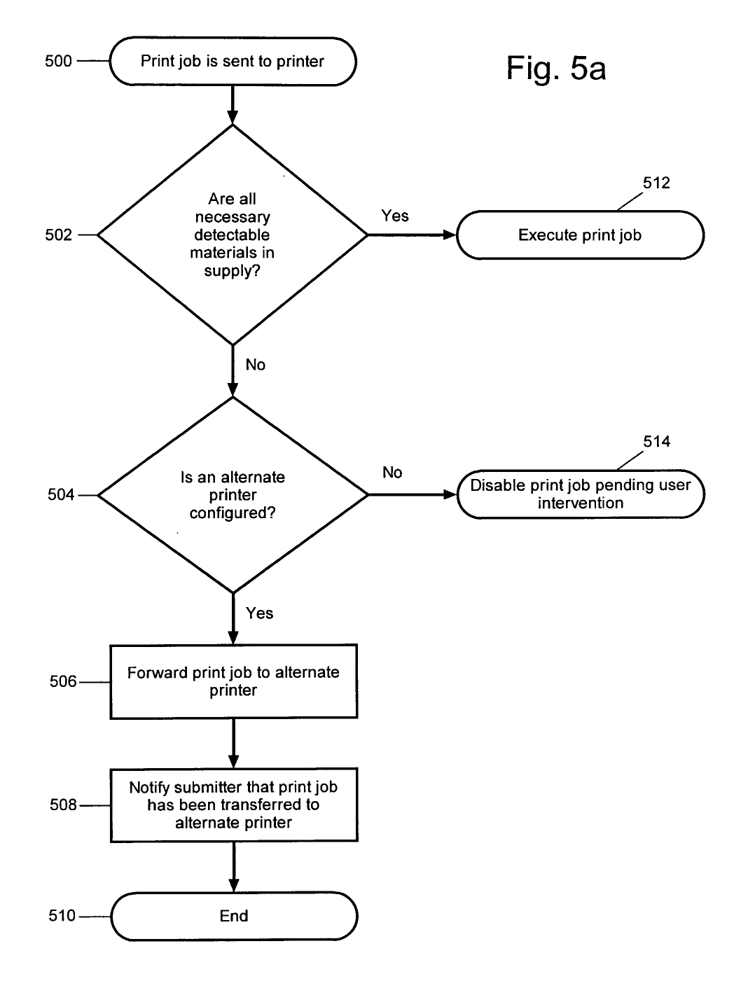

FIG. 5a illustrates by example another method of the invention, where by a print job submitted to a printer may be forwarded to another compatible printer if the original printer is disabled due to a shortage of a material needed by the printing process, the shortage of the material being detectable by the printer. Examples of such materials are inks, toners, and paper. A print job is submitted to a printer, in step 500. In step 502 a decision is made as to whether or not the printer is in a disabled condition due to the shortage of a material. If no material shortage is detected, execution continues to step 512, otherwise execution continues in step 504. In step 512 the print job is executed, producing the normal print output. A decision is made in step 504 as to whether or not an alternate printer is configured. Such configuration must at least include a logical location to where a print job may be forwarded. If an alternate printer has not been configured, execution is halted in step 514 until user intervention occurs. If an alternate printer has been configured, execution proceeds to step 506. In step 506 the print job is forwarded to the alternate printer specified in the configuration. The print job may be forwarded without further processing or conversion, as the alternate printer is required to be compatible. Execution proceeds from step 506 to optional step 508, or to step 510 if optional step 508 is omitted ending the process. In step 508 the submitter of the print job is notified that the print job has been forwarded to the alternate printer, whereby a user may be informed where to collect the print output.

FIG. 5b illustrates by example a related method of the invention, whereby a print job submitted to a printer may be forwarded to another compatible printer if the original printer is disabled due to a shortage of a detectable material needed by the printing process. The printer forwards the print job only if an interrogation of the alternate compatible printer reports that materials are available in the alternate printer. A print job is submitted to a printer, in step 520. In step 522 a decision is made as to whether or not the printer is in a disabled condition due to the shortage of a material. If no material shortage is detected, execution continues to step 530, otherwise execution continues in step 524. In step 530 the print job is executed, producing the normal print output. A decision is made in step 524 as to whether or not an alternate printer is configured. Such configuration may include a logical location to where a print job may be forwarded. If an alternate printer has not been configured, execution is halted in step 532 until user intervention occurs. If an alternate printer has been configured execution proceeds to step 526, wherein the alternate printer is interrogated as to whether or not the necessary detectable print materials are available to complete the print job on the alternate computer. Execution then proceeds to step 528, in which a positive result of the interrogation of step 526 causes the program to branch to step 534, or to step 532 otherwise. In step 534 the print job is forwarded to the alternate printer specified in the configuration. The print job may be forwarded without further processing or conversion, as the alternate printer is required to be compatible. Execution proceeds from step 534 to optional step 536, or to step 538 if optional step 536 is omitted ending the process. In step 536 the submitter of the print job is notified that the print job has been forwarded to the alternate printer, whereby a user may be informed where to collect the print output.

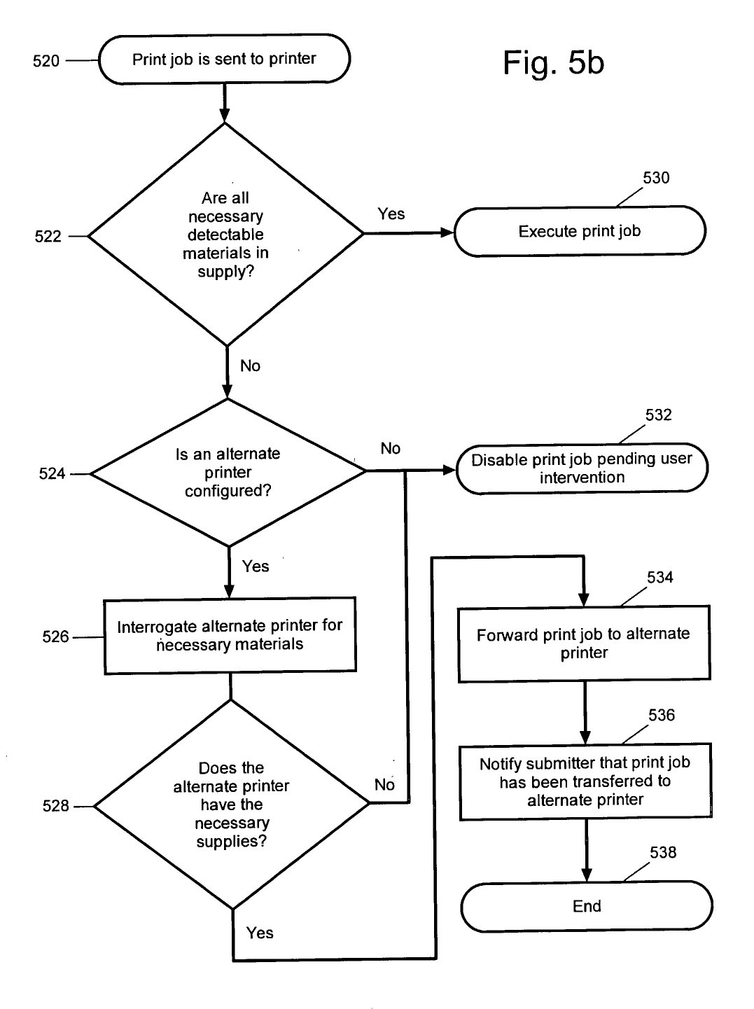

FIG. 6 illustrates by example a system of the invention, whereby a print job may be forwarded to an alternate printer of the same type. Host 600 is a computer or workstation with application software capable of submitting a print job to a printer 602. Printer 602 contains software which detects the availability of materials used in the printing process such as inks, toner, and paper. Printer 602 may have a configuration element whereby the logical location of an alternate printer may be specified, if providing only a default location is insufficient. Printer 602 also contains software which forwards a submitted print job to compatible alternate printer 604 if materials are detected to be absent, given that printer 602 has been configured with the logical location of alternate printer 604. Software contained in printer 602 may also forward the logical location of the submitter with the print job. Alternate printer 604 is the same model of printer as printer 602, and is thus compatible. Alternate printer 604 contains software to receive and execute a forwarded print job. Alternate printer 604 may alternatively contain software to receive a submitter logical location from printer 602, and send a notification message to host 600 specifying the logical location of alternate printer 604. Network 606 is shown illustrating one example of a communications path from host 600 to printer 602, printer 602 to printer 604, and printer 604 to host 600. Other communications paths may be used as will be recognized by those skilled in the art.

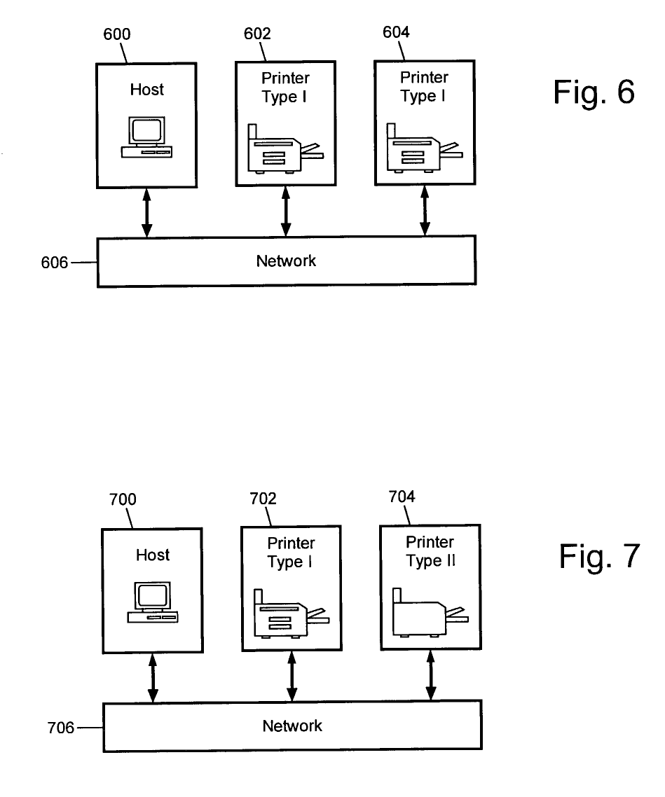

FIG. 7 illustrates by example a system of the invention, whereby a print job may be forwarded to an alternate printer of a different, but compatible type. Host 700 is a computer or workstation with application software capable of submitting a print job to a printer 702. Printer 702 contains software which detects the availability of materials used in the printing process such as inks, toner, and paper. Printer 702 may have a configuration element whereby the logical location of an alternate printer may be specified, if providing only a default location is insufficient. Printer 702 also contains software which forwards a submitted print job to compatible alternate printer 704 if materials are detected to be absent, given that printer 702 has been configured with the logical location of alternate printer 704. Software contained in printer 702 may also forward the logical location of the submitter with the print job. Alternate printer 704 is not the same model of printer as printer 702, but is compatible in that a printer language file sent to printer 702 may be interpreted by printer 704 and produce similar output. The output of alternate printer 704 may differ somewhat from printer 702 in that inherent properties such as the resolution, pigments, margins, fonts, pagination, and other printer specific properties of alternate printer 704 may cause noticeable differences, but that output must produce at least text and images that are recognizably the same and complete. Alternate printer 704 contains software to receive and execute a forwarded print job. Alternate printer 704 may alternatively contain software to receive a submitter logical location from printer 702, and send a notification message to host 700 specifying the logical location of alternate printer 704. Network 706 is shown illustrating one example of a communications path from host 700 to printer 702, printer 702 to alternate printer 704, and alternate printer 704 to host 700. Other communications paths may be used as will be recognized by those skilled in the art.

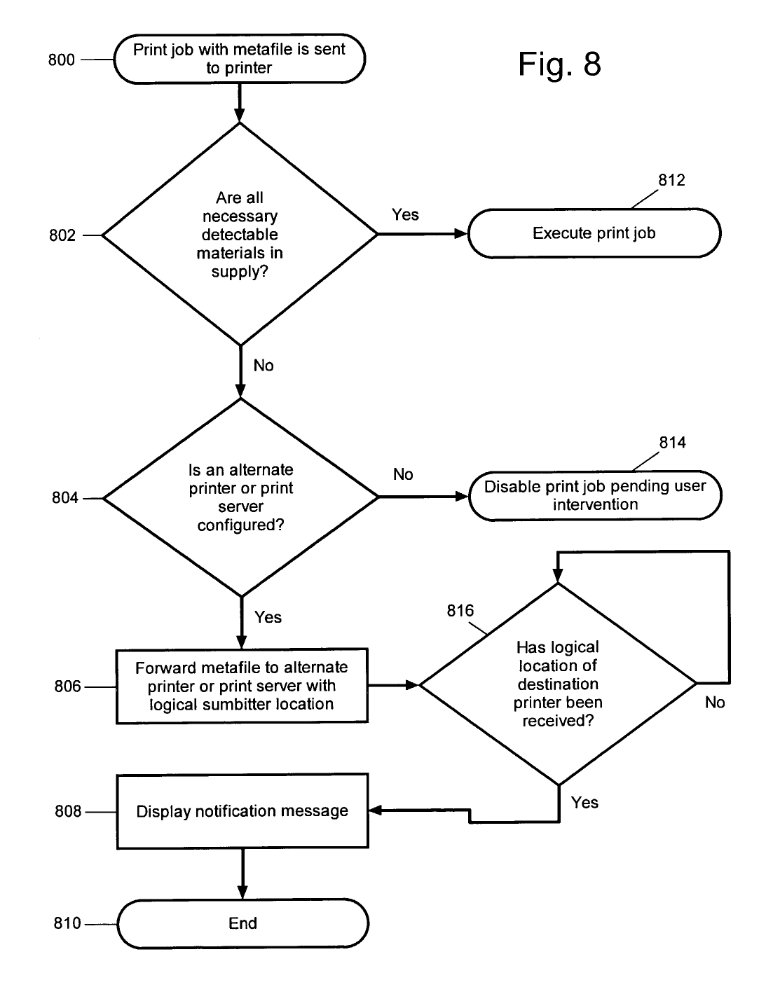

FIG. 8 illustrates by example another method of the invention, whereby a metafile accompanied in or contained in a print job submitted to a printer may be forwarded to a print server if the printer is disabled due to a shortage of a material needed by the printing process, the shortage of material being detectable by the printer. Examples of such materials are inks, toners, and paper. A print job is submitted to a printer, in step 800. In step 802, a decision is made as to whether or not the printer is in a disabled condition due to the shortage of a necessary detectable material. If there is no detectable shortage execution continues to step 812, otherwise execution proceeds to step 804. In step 812 the print job is executed following which execution ends. In step 804, a decision is made as to whether or not an alternate printer or print server has been configured. Such configuration must at least include a logical location to where a metafile may be forwarded. If an alternate printer or print server has not been configured, execution is halted in step 814 until user intervention occurs. Otherwise, execution proceeds to step 806. In step 806 the metafile is forwarded to the alternate printer or print server specified in the configuration. Execution may then proceed to optional step 816, or execution may end in step 810. If optional step 816 is executed, the process waits for a message containing the logical location of the destination printer to arrive. A timeout period, or other means, may be implemented to keep the process from becoming trapped in step 816. Execution continues to optional step 808 which displays a notification message indicating the print job has been forwarded to the printer at the logical location received in step 816, following which execution ends in step 810.

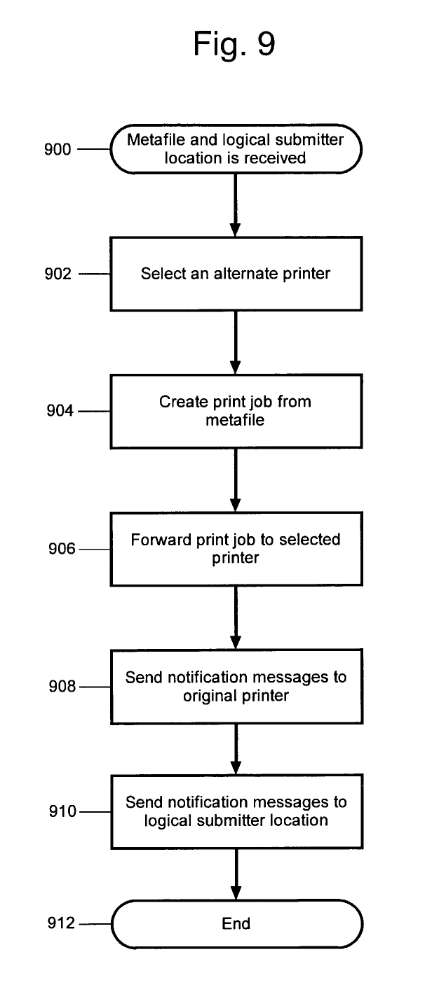

FIG. 9 illustrates by example another method of the invention, whereby a print server may accept forwarded metafiles from disabled printers, causing those metafiles to be printed to one or more alternate printers. A metafile is received, as shown in step 900. A logical location, shown by example as the logical location of the submitter, may optionally be received with the metafile, indicating a location to where notifications may be sent. Two examples of a logical location are the location of the workstation from which a print job was initiated, and the location of a printer which forwarded the metafile. Execution proceeds to step 902, in which an alternate printer is selected. A set of alternate printers is required to be configured for this selection. If only one printer is included in the set, only one selection is possible. If multiple alternate printers are configured, an algorithm executes to determine the selection. One example of such an algorithm is round-robin. Another algorithm example examines the metafile for color properties, selecting a monochrome or color printer on determination of those color properties. Another example requests the status of alternate printers and selects one that is not busy, or is least busy. Those skilled in the art will understand there are many possible and useful algorithms which may be chosen for this embodiment. Once the selection has been made in step 902, a print job is created from the received metafile for the selected printer, as shown in step 904. Such print job creation is well understood in the prior art, having a similar process by which a personal computer converts a metafile to a print job as illustrated in step 104 of FIG. 1. The print job is then forwarded to the selected printer in step 906. Step 908 is optional, whereby a notification message is sent to the printer that submitted the metafile noting the logical location of the selected alternate printer. This notification is useful to inform an operator where to collect his print job at the printer he sent an original print job to. Step 910 is also optional, whereby a notification message is sent to a logical location sent with the metafile, noting the logical location of the selected alternate printer. This notification is useful to inform an operator where to collect his print job at the workstation from which a print job was originated, or to another location if desired. Following optional execution of steps 908 and 910, execution is ended in step 912. Those skilled in the art will recognize the server methods of FIG. 9 may be extended to receive metafiles from non-printer appliances such as workstations.

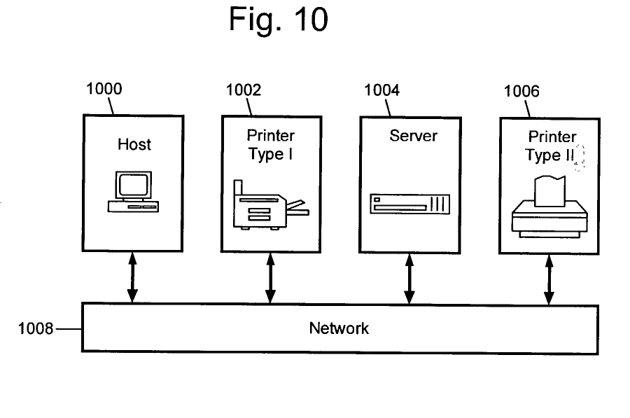

FIG. 10 illustrates by example a system of the invention, whereby a print job containing a metafile may be forwarded to an alternate printer through an alternate print server. Host 1000 is a computer or workstation with application software capable of submitting a print job to a printer 1002. Such a print job contains a metafile, whereby a print job for a different printer than 1002 may be generated. Printer 1002 contains software which detects the availability of materials used in the printing process such as inks, toner, and paper. Printer 1002 may have a configuration element whereby the logical location of an alternate printer may be specified, if providing only a default location is insufficient. Printer 1002 also contains software which forwards a metafile submitted with a print job to alternate print server 1004 if materials are detected to be absent, given that printer 1002 has been configured with the logical location of alternate print server 1004. Software contained in printer 1002 may also forward the logical location of the submitter with the metafile to the alternate print server 1004. Alternate print server 1004 is a server which has software to receive metafiles from printer 1000, selects an alternate printer 1006 from a set of alternate printers, convert such metafiles to print jobs, and forward those print jobs to an alternate printer 1006. Software may also be embodied in alternate print server 1004 which returns a message to printer 1002, or to a logical location sent with a metafile indicating the logical location of selected alternate printer 1006. Alternate printer 1006 may interpret a different print language than printer 1000, although not necessary. Alternate printer 1006 contains software to receive and execute a print job produced by alternate print server 1004. Network 1008 is shown illustrating one example of a communications path from host 1000 to printer 1002, printer 1002 to server 1004, server 1004 to host 1000, and server 1004 to alternate printer 1006. Other communications paths may be used as will be recognized by those skilled in the art.

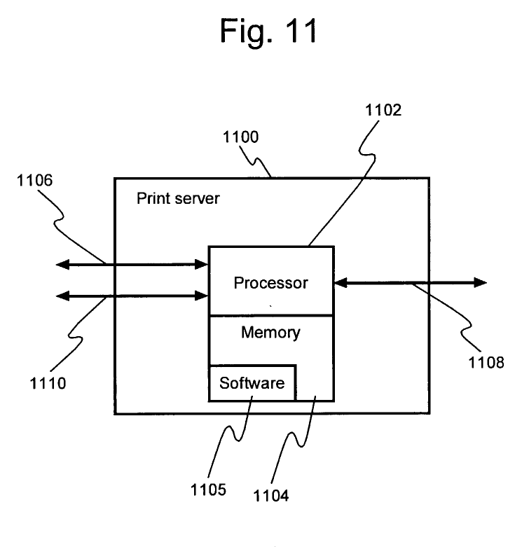

FIG. 11 illustrates by example a print server system of the invention. A printer server 1100 contains a processor 1102, and memory 1104 whereon software is contained. Interface 1106 provides a communications channel for processor 1102 to receive print jobs from printers, such print jobs containing at least a metafile and optionally a logical location. Interface 1108 provides another communications channel for processor 1102 to submit a print job to alternate printers. Interface 1110 provides another communications channel for processor 1102 to send a message to the logical location optionally provided with the print job. Software 1105 contained in memory 1104 serves to receive metafiles from printers through interface 1106, select an alternate printer from a set of alternate printers if more that one is available, form a new print job containing printer language instructions from the metafile, and forward that print job to the selected alternate printer through interface 1108. The software may also serve to send a message containing a logical location or identifier for the selected alternate printer to the logical location provided with the print job through interface 1110. The software may also serve to send a message containing a logical location or identifier for the selected alternate printer to the printer that submitted the metafile. The set of alternate printers may represented in memory 1104. The set of alternate printers may be only one alternate printer, in which case selecting an alternate printer becomes trivial, and interface 1108 may be a parallel or serial port of the common printer and computer configuration. Examples of the configuration of the set include entering a set of logical locations to memory, and scanning a sub-network for printers. Those skilled in the art will recognize the server system of FIG. 11 may be extended to receive metafiles from non-printer appliances such as workstations.

Other embodiments of the invention provide multiple bypass modes. One of these embodiments, for example, is a printer that functions to use both the substitution modes of substituting process black for black and grayscale for color. Others of these embodiments are printers that function to use both substitution modes and forwarding modes as bypass modes. Others of those embodiments permit a user to configure a priority for the available multiple bypass modes.

For all of the embodiments of the invention which perform bypass operations, a configuration option may be provided to receive a user's indication as to whether or not performing the bypass operation is acceptable. This configuration option may be as simple as a binary element, or may contain multiple settings and modes whereby the user may indicate his intentions in various situations and combinations of print job states and other state configurations as will be understood by those skilled in the art.

While the present invention has been described and illustrated in conjunction with a number of specific embodiments, those skilled in the art will appreciate that variations and modifications may be made without departing from the principles of the inventions as herein illustrated, described and claimed.

The present invention may be embodied in other specific forms without departing from their spirit or characteristics. The described embodiments are to be considered in all respects as only illustrative, and not restrictive. The scope of the invention is, therefore, indicated by the appended claims, rather than the foregoing description. All changes that come within the meaning and range of equivalency of the claims are to be embraced within their scope.

1. A method of alternate execution of a print job submitted to a primary printer, comprising the steps of:
acquiring a print job at a primary printer;
making a determination of whether or not at least one detectable colorant is unavailable to print the acquired print job;
and continuing the execution of the acquired print job by a bypass operation, said continuing occurring only if said making a determination indicates at least one detectable colorant is unavailable.

2. The method of claim 1, wherein:
the primary printer is a color printer designed to deposit black and chromatic colorants to media in combination to produce a spectrum of colors on the media;
and the bypass operation comprises the steps of:
(i) converting the acquired print job to a degraded print job, said converting substituting process black in the degraded print job for true black in the acquired print job;
(ii) executing the degraded print job;
and (iii) optionally detecting the availability of process black colorants, said detecting preventing at least said executing of a degraded print job.

3. The method of claim 1, wherein:
the primary printer is a color printer designed to deposit black and chromatic colorants to media in combination to produce a spectrum of colors on the media;
and the bypass operation comprises the steps of:
(i) converting the acquired print job to a degraded print job, said converting substituting grayscale in the degraded print job for color in the acquired print job;
(ii) executing the degraded print job;
and (iii) optionally detecting the availability of black colorant, said detecting preventing at least said executing of a degraded print job.

4. The method of claim 1, whereby the bypass operation comprises the steps of:
forwarding the acquired print job to a compatible alternate printer;
executing the acquired print job on the alternate printer;
and optionally sending a notification message indicating that the print job has been forwarded, said sending optionally indicating the destination of the print job.

5. The method of claim 4, whereby:
the bypass operation further comprises the step of determining if the alternate printer has the necessary colorants to print the acquired print job;
and said forwarding occurs only if said determining indicates the alternate printer has the necessary colorants to print the acquired print job.

6. The method of claim 1, whereby:
the print job contains or accompanies a metafile, and the bypass operation comprises the steps of:
(i) forwarding the metafile of the acquired print job to a print server;
(ii) creating a set of printer instructions from the metafile at the print server;
(iii) sending the set of printer instructions to an alternate printer;
and (iv) optionally sending a notification message indicating that the print job has been forwarded, said sending optionally indicating the destination of the print job.

7. The method of claim 1, whereby:
the print job contains a metafile, and the bypass operation comprises the steps of:
(i) forwarding the metafile of the acquired print job to an alternate printer;
(ii) creating a set of printer instructions from the metafile at the alternate printer;
(iii) executing the set of printer instructions at the alternate printer;
and (iv) optionally sending a notification message indicating that the print job has been forwarded, said sending optionally indicating the destination of the print job.

8. The method of claim 1, further comprising:
reading a configuration option set by an operator indicating whether or not a bypass operation is acceptable;
and said continuing occurs only if said reading indicates that a bypass operation is acceptable.

9. The method of claim 1, wherein:
the primary printer is a laser printer;
and the detectable colorants include toner.

10. The method of claim 1, wherein:
the primary printer is a thermal ink jet printer;
and the detectable colorants include ink.

11. A printing system capable of bypassing a disabling condition of unavailability of colorant, comprising:
a print engine designed to receive colorants from one or more cartridges;
a print controller enabled to control said print engine;
memory readable by said print controller;
one or more general interfaces to said print controller;
one or more detectors, each of said detectors enabled to detect the unavailability of at least one colorant to said print engine;
and software contained in said memory, said software providing the functions of:
(i) receiving print jobs through said general interfaces, said print jobs including a first set of printer language instructions;
(ii) reading said detectors;
and (iii) performing at least one bypass operation to continue a print job if said detectors indicate that at least one colorant is unavailable.

12. The printing system of claim 11, wherein:
said print engine is designed to deposit black and chromatic colorants to media to produce a spectrum of colors on the media;
at least one of said detectors may be enabled to detect the unavailability of black colorant;
and said software provides the function of printing process black for true black as a bypass operation.

13. The printing system of claim 11, wherein:
said print engine is designed to deposit black and chromatic colorants to media to produce a spectrum of colors on the media;
said detectors may be enabled to detect the unavailability of chromatic colorants;
and said software provides the function of printing grayscale for color as a bypass operation.

14. The printing system of claim 11, wherein said software provides the function of forwarding the print job to a compatible alternate printer through said general interfaces as a bypass operation.

15. The printing system of claim 14, wherein said software further provides the function of sending a notification message indicating that a print job has been forwarded, said sending optionally indicating the destination of the print job.

16. The printing system of claim 11, wherein:
said software is enabled to receive print jobs containing a metafile;
and said software provides the function of forwarding at least the metafile of a received print job to a print server through said general interfaces.

17. The printing system of claim 16, further comprising:
a processor connected to said one or more interfaces;
an alternate printer interface of said processor enabling said processor to transmit a set of printer language instructions to an alternate printer;
second memory readable by said processor;
and second software contained in said second memory, said second software providing the functions of:
(i) receiving a metafile through said one or more interfaces;
(ii) converting the received metafile to a set of printer language instructions;
and (iii) forwarding a set of printer language instructions to an alternate printer through said alternate printer interface.

18. The printing system of claim 11, wherein:
said print engine is designed to deposit black and chromatic colorants to media to produce a spectrum of colors on the media;
at least one of said detectors may be enabled to detect the unavailability of black colorant, and said detectors may also be enabled to detect the unavailability of chromatic colorants;
and said software provides the functions of:
(i) receiving print jobs through said general interfaces, said print jobs including a first set of printer language instructions;
(ii) reading said detectors;
(iii) converting the print job such that true black is converted to process black, if said reading indicates that black colorant is unavailable;
(iv) converting the print job such that color is converted to grayscale, if said reading indicates that a chromatic colorant is unavailable;
and (v) executing the converted print job.

19. The printing system of claim 11, wherein:
said print engine is designed to deposit black and chromatic colorants to media to produce a spectrum of colors on the media;
at least one of said detectors may be enabled to detect the unavailability of black colorant, and said detectors may also be enabled to detect the unavailability of chromatic colorants;
and said software provides the functions of:
(i) receiving print jobs through said general interfaces, said print jobs including a first set of printer language instructions;
(ii) reading said detectors;
(iii) executing the print job if said reading indicates that all colorants are available;
(iv) converting the print job such that true black is converted to process black, if said reading indicates that black colorant is unavailable and said reading indicates that all chromatic colorants are available;
(v) converting the print job such that color is converted to grayscale, if said reading indicates that a chromatic colorant is unavailable and said reading indicates that black colorant is not unavailable;
(vi) executing a converted print job, if a converted print job is produced;
and (vii) forwarding a received print job to an alternate receiver, if said reading indicates that black colorant and at least one chromatic colorants are unavailable.

20. The printing system of claim 11, wherein:
said print engine is designed to deposit black and chromatic colorants to media to produce a spectrum of colors on the media;
at least one of said detectors may be enabled to detect the unavailability of black colorant, and said detectors may also be enabled to detect the unavailability of chromatic colorants;
and said software provides the functions of:
(i) receiving print jobs through said general interfaces, said print jobs including a first set of printer language instructions;
(ii) reading said detectors;
(iii) executing the print job if said reading indicates that all colorants are available;
(iv) testing for the availability of an alternate receiver enabled to accept a print job;
(v) forwarding a received print job to an alternate receiver, if said reading indicates that at least one colorant is unavailable and said testing indicates that an alternate receiver is available;
(vi) converting the print job such that true black is converted to process black, if (1) said reading indicates that black colorant is unavailable, (2) said reading indicates that all chromatic colorants are available and (3) said testing indicates that an alternate receiver is not available;
(vii) converting the print job such that color is converted to grayscale, if (1) said reading indicates that a chromatic colorant is unavailable, (2) said reading indicates that black colorant is not unavailable and (3) said testing indicates that an alternate receiver is not available;
(viii) executing a converted print job, if a converted print job is produced.

21. The printing system of claim 11, wherein:
said software further provides the function of reading a setting configurable by a user, said software further performing a bypass operation only if the setting indicates that performing a bypass operation is acceptable.

22. A printing system capable of bypassing a disabling condition of unavailability of colorant, comprising:
a print engine designed to consume colorants in the process of printing;
means of controlling said print engine;
means of receiving print jobs to said means of controlling;
means of detecting the unavailability of at least one colorant to said print engine;
and means of conditionally performing a bypass operation if means of detecting indicates that at least one colorant is unavailable.
